(19) United States
(12) Patent Application Publication
(10) Pub. No.: US 2018/0152063 A1
(43) Pub. Date: May 31, 2018

(54) STATOR RING FOR AN ELECTRIC GENERATOR, AND GENERATOR AND WIND TURBINE HAVING SAID STATOR RING

(71) Applicant: Wobben Properties GmbH, Aurich (DE)

(72) Inventors: Frank KNOOP, Aurich (DE); Jan Carsten ZIEMS, Aurich (DE)

(21) Appl. No.: 15/578,082

(22) PCT Filed: Jun. 3, 2016
(86) PCT No.: PCT/EP2016/062605

§ 371 Date: Nov. 29, 2017

(30) Foreign Application Priority Data
Jun. 11, 2015 (DE) 10 2015 210 662.4

(51) Int. Cl. H02K 1/20; H02K 1/18; H02K 9/22; H02K 3/12

(52) U.S. Cl. CPC H02K 1/20; H02K 3/12; H02K 9/22; H02K 1/185

(57) ABSTRACT

A stator ring for an electric generator is disclosed. The stator ring may be for a synchronous generator or ring generator of a wind power installation. The stator ring has a plurality of grooves for receiving the stator winding and a magnetic yoke. The stator ring has a region of the magnetic yoke that has at least one cooling recess having two mutually opposite cooling walls. Arranged in the cooling recess are a first and a second heat sink which have respective mutually facing wedge surfaces which slide against each other. Opposite the respective wedge surface is a thermal coupling surface which faces towards the cooling walls for dissipating heat energy from one of the cooling walls and are displaced relative to each other in such a way that the thermal coupling surfaces are pressed against the cooling walls.

### BACKGROUND

### Technical Field

The present invention concerns a stator ring for an electric generator, in particular a synchronous generator or a ring generator of a wind turbine. The invention further concerns such a synchronous generator or ring generator. In addition the invention concerns a wind turbine having such a generator. Finally the invention also concerns a use of a heat sink arrangement for dissipating heat energy from a cooling recess.

### Description of the Related Art

Stator rings of the above-indicated kind are basically known. They usually have a plurality of grooves for receiving the stator winding, in which electric power is induced by the rotor as it moves along same. The stator rings are typically of such a configuration that adjacent to the portion which carries the grooves they have a magnetic yoke. In the case of stator rings for internal rotors the magnetic yoke is disposed radially outside the region in which the grooves are provided. In the case of stator rings for external rotors the arrangement is correspondingly reversed. Here the grooves are radially outside the magnetic yoke.

Heat is generated in an electric generator of the above-indicated kind and in particular in the stator ring as a consequence of the induction of electric power. In order to minimize the power losses caused, efficient heat dissipation is desirable.

Various approaches for also directly dissipating heat out of the stator ring are known from the state of the art. For example EP 2 419 991 B1 discloses the use of pipes which extend through the stator ring and are hydraulically expanded in order to be in firm contact in the recesses, which is intended to provide for better heat transfer.

While the cooling action in accordance, for example, with the above-indicated configuration is in practice generally considered to be operational nonetheless the required apparatus complication and expenditure and also the amount of time required for fitting the pipes and for expanding the pipes is considered to be a disadvantage. In addition, once the pipes have been expanded, they can only be removed from the stator ring again with difficulty. That is considered to be a disadvantage.

### BRIEF SUMMARY

With that background in mind, provided is a stator ring of the above-indicated kind. In particular provided is a stator ring which permits efficient cooling of the stator ring while involving a reduced degree of fitment complication and expenditure. In addition, provided is a stator ring having a cooling means in which the cooling means can also be more easily subsequently removed.

Provided is a stator ring of the kind set forth in the opening part of this specification, insofar as the stator ring in the region of the magnetic yoke has at least one cooling recess having two mutually opposite cooling walls, wherein arranged in the cooling recess are a first and a second heat sink which have respective mutually facing wedge surfaces which slide against each other and opposite the wedge surface a respective thermal coupling surface which faces towards the cooling walls for dissipating heat energy from one of the cooling walls and are displaced relative to each other in such a way that the thermal coupling surfaces are pressed against the cooling walls. The wedge surfaces which slide against each other are so oriented that upon displacement of the heat sinks relative to each other the spacing between the thermal coupling surfaces of the heat sinks is altered.

The realization that with a wedge-shaped heat sink configuration it is easily possible to fit the heat sinks into the cooling recess as they do not yet have to be directly braced is made use of. Subsequent bracing thereof by means of displacement of the heat sinks can be effected in a very simple fashion from the exterior without involving significant apparatus complication. Likewise it is also possible for the bracing action to be undone from the outside with apparatus complication which is of an unchanged slight degree. Consequently it is possible to very easily provide good heat-conducting coupling between the heat sinks and the stator ring with the wedge-shaped heat sinks which slide against each other. Retro-fitment of a cooling system with the first and second heat sinks can also be easily implemented.

An advantageous development provides that one or both heat sinks respectively have at least one fluid passage for connection to a fluid cooling system, in particular to a cooling water circuit.

In a further preferred configuration the contour of the thermal coupling surface of the first and second heat sinks is adapted to the contour of the cooling wall, to which the thermal coupling surfaces face. Admittedly with a sufficiently strong pressing action adaptation of the surface contour also occurs by virtue of elastic deformation, but it is found to be advantageous for the surfaces to be so adapted to each other that, even with a low pressure or in the absence of surface pressure, it is already possible to provide for surface contact between the thermal coupling surfaces and the cooling walls. That improves the thermal coupling effect.

Preferably the thermal coupling surfaces and/or the wedge surfaces are respectively provided with a heat-conducting paste.

In a further preferred embodiment one or both of the heat sinks are at least partially and preferably completely formed from one of the materials: aluminum, aluminum alloy, copper and copper alloy.

In an embodiment of the invention is based on a structure such that the first and second heat sinks are respectively made in one piece. According to a preferred embodiment however it is alternatively provided that at least one of the heat sinks is of a multi-part configuration such that a first portion has the wedge surface for interaction with the respective other heat sink and a second portion has the at least one fluid passage. It is possible in that way to achieve advantages in terms of manufacturing technology.

Depending on how much space the stator ring is to occupy in the generator in the radial direction, in consideration of the structure involved, it may either be advantageous to press the first and second heat sinks in the radial direction by displacement or to press them in the peripheral direction by displacement. Correspondingly in accordance with a first alternative preferred configuration the mutually opposite cooling walls of the at least one cooling recess are spaced from each other in the radial direction while in a second preferred alternative configuration they are spaced from each other in the peripheral direction. With a spacing in the radial direction from each other it is possible to optionally distribute a larger number of cooling recesses and heat sinks around the periphery of the stator ring while with a spacing in the peripheral direction from each other the magnetic yoke of the stator ring can be narrower.

In a particularly preferred embodiment the stator ring has a plurality of stator lamination sets, wherein the cooling recesses extend through the stator lamination sets, preferably from a first axial end of the stator ring to an opposite second axial end of the stator ring. The term stator lamination set is used to denote an arrangement comprising a plurality of stator laminations which are stacked one above the other and which are preferably designed in the manner of dynamo laminations. The stator laminations can be separated from each other for example by means of insulating paper or by means of insulating lacquering.

In a preferred embodiment, the cooling recess is of a rectangular cross-section, in particular in the direction in which the recess extends, which is preferably the axial direction of the stator ring. In the case of a cooling recess of rectangular cross-section the geometries of the heat sinks can be particularly easily manufactured. The thermal coupling surfaces facing towards the cooling walls are then also to be flat.

In a further preferred embodiment of the stator ring the cooling recess is a recess which is provided for fitment or fixing purposes in the stator ring and which has possibly been subsequently increased in size for adaptation to the heat sinks.

In regard to this aspect use is made in particular of the fact that, instead of producing dedicated cooling recesses for the heat sinks, it is already possible to use those openings which are provided in any case in the magnetic yoke for fitting or fixing the stator laminations. Depending on the desired cooling performance it may be necessary for those fitting or fixing recesses further to be increased in size or adapted to the geometry of the first and second heat sinks so that it is possible to implement assembly and removal of the heat sinks. A particular synergy is achieved however by the second use of those recesses for later receiving the heat sinks.

In a further aspect as indicated hereinbefore disclosed is an electric generator, in particular a synchronous generator or ring generator of a wind turbine, comprising a rotor and a stator, wherein the stator has a stator ring.

In relation to the electric generator, disclosed is the stator ring is designed in accordance with one of the above-described preferred embodiments. The generator is preferably a generator of a diameter of more than one meter, in particular several meters. In particular the generator is a generator in power class>1 MW. In addition the generator in particular is a slow-rotating generator involving speeds of revolution of less than 40 revolutions per minute, in particular less than 30, and in the case of particularly large structures even less than 20 revolutions per minute. The weight of such a generator is more than one tonne, in particular several tonnes.

The need for efficient heat dissipation, also by means of fluid cooling, is explained in consideration of the above-indicated orders of size of the generator.

In a third aspect as mentioned in the opening part of this specification, disclosed is a wind turbine, in particular a gearless wind turbine, comprising an electric generator which in particular is a synchronous generator or ring generator. Disclosed is a wind turbine, where the generator is designed in accordance with one of the above-described preferred embodiments and in particular has a stator ring according to one of the preferred embodiments described herein.

According to a fourth aspect, disclosed is the use of a heat sink arrangement for the dissipation of heat energy from a cooling recess in the stator ring of an electric generator of a wind turbine. In regard to such a use, the cooling recess has two mutually opposite cooling walls, wherein the heat sink arrangement has a first and a second heat sink which respectively have a thermal coupling surface facing towards the cooling walls, and are displaced relative to each other in such a way that the thermal coupling surfaces are pressed against the cooling walls. The heat sink arrangement used is preferably designed in accordance with one of the above-described embodiments.

### BRIEF DESCRIPTION OF THE SEVERAL VIEWS OF THE DRAWINGS

The invention is described in greater detail hereinafter by means of a preferred embodiment with reference to the accompanying Figures in which:

FIG. 1 shows a diagrammatic perspective view of a wind turbine,

FIG. 2 shows a diagrammatic perspective sectional view of a pod of the wind turbine of FIG. 1,

FIG. 3 shows a simplified diagrammatic perspective view of a stator of the wind turbine of FIGS. 1 and 2,

FIG. 4 shows a partial diagrammatic sectional view through the stator of FIG. 3,

FIG. 5 shows a diagrammatic cross-sectional view transversely relative to the view of FIG. 4, and

FIGS. 6a-e show various projection views of a heat sink arrangement for the generator as shown in the foregoing Figures.

### DETAILED DESCRIPTION

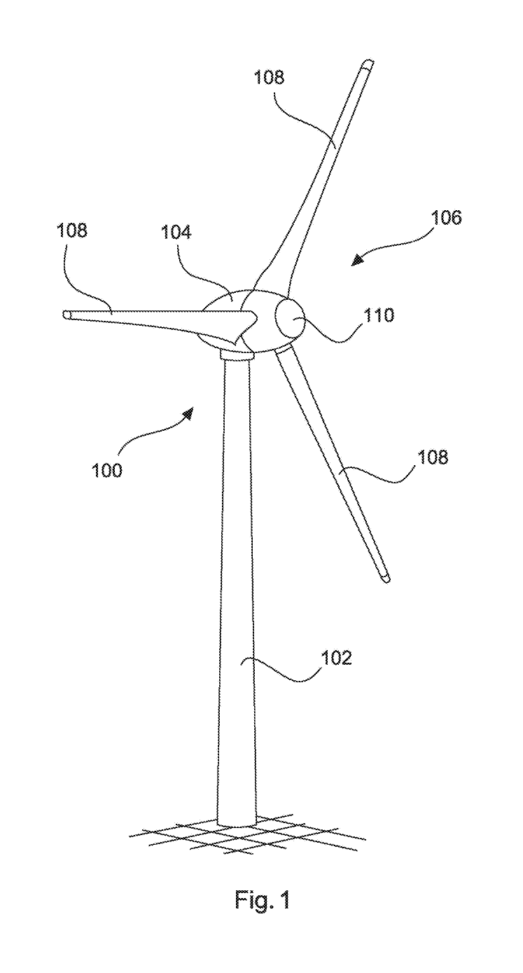

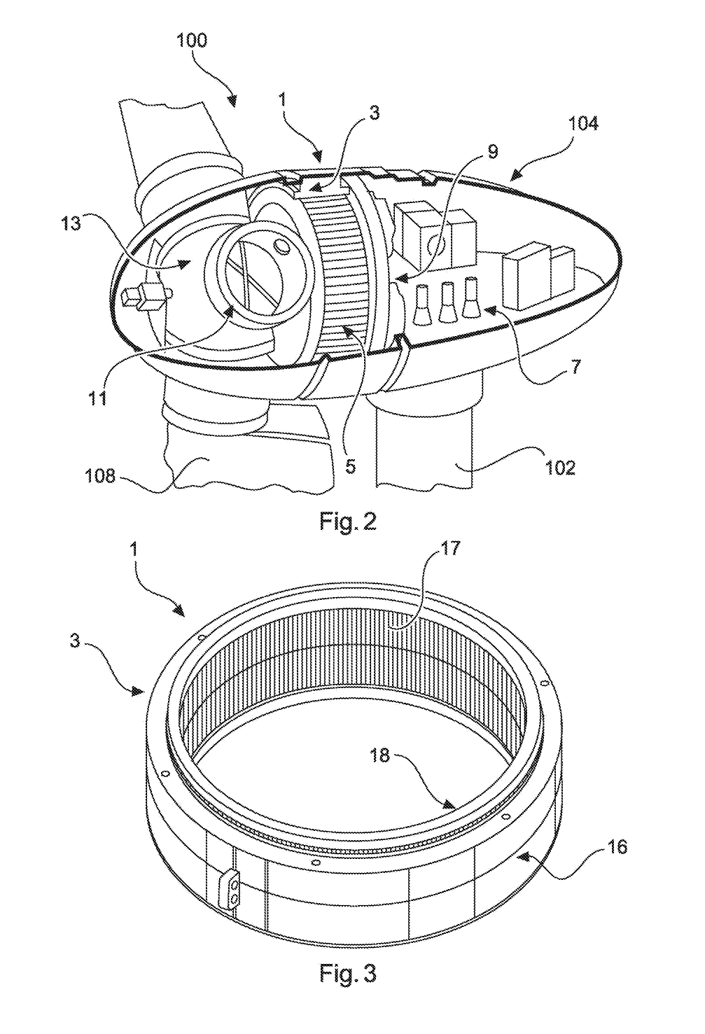

FIG. 1 shows a wind turbine 100 comprising a pylon 102 and a pod 104. Arranged at the pod 104 is a rotor 106 having three rotor blades 108 and a spinner 110. In operation the rotor 106 is caused to rotate by the wind and thereby drives a generator 1 (FIG. 2) in the pod 104.

The pod 104 is shown in FIG. 2. The pod 104 is mounted rotatably to the pylon 102 and drivingly connected in generally known manner by means of an azimuth drive 7. In a configuration which is also generally known disposed in the pod 104 is a machine carrier 9 which holds a synchronous generator 1. The synchronous generator 1 is designed in accordance with the present invention and is in particular a slow-rotating, multi-pole synchronous ring generator. The synchronous generator 1 has a stator 3 and an internal rotor 5, also referred to as the rotor member. The rotor or rotor member 5 is connected to a rotor hub 13 which transmits rotational movement of the rotor blades 108, caused by the wind, to the synchronous generator 1.

FIG. 3 shows the stator 3 on its own. The stator 3 has a stator ring 16 having an internal peripheral surface 18. Provided in the internal peripheral surface 18 is a plurality of grooves 17 adapted to receive the stator winding in the form of conductor bundles.

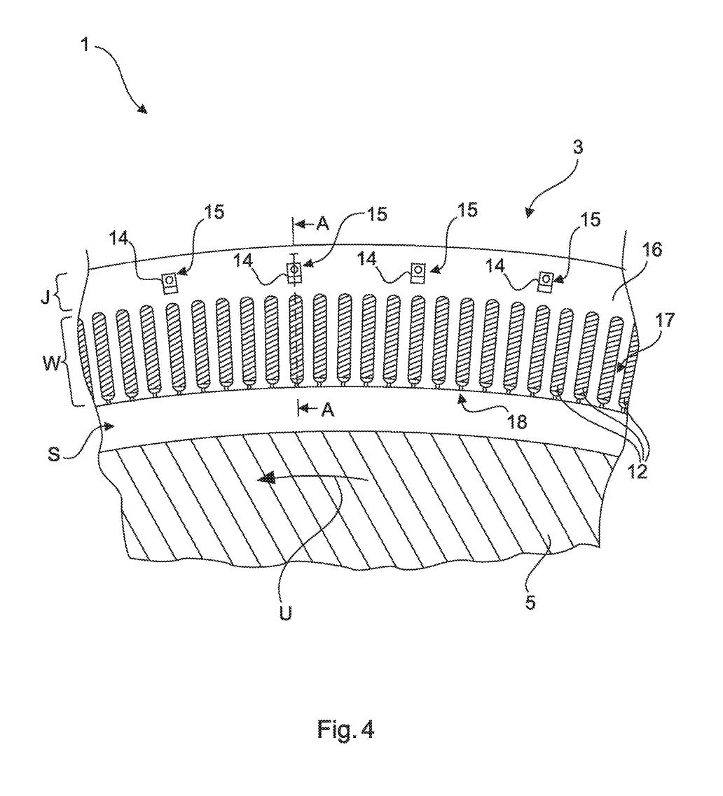

As can be seen from the cross-sectional view in FIG. 4 the stator ring 16 of the stator 3 has a stator winding in a first radial region W. The stator winding is fitted in the form of conductor bundles 12 in the grooves 17 which extend from the internal peripheral surface 18. The magnetic yoke J is adjacent to the region W. In the illustrated generator 1 with an internal rotor, indicated by a rotor 5 which moves in the peripheral direction U within the stator ring 16, the magnetic yoke J is radially outside the region W having the stator winding. In an alternative generator, which has an external rotor (not shown), the rotor would rotate radially outside the stator and the magnetic yoke would accordingly be arranged radially within the region of the stator windings adjacent to that region. Additional illustration in the drawing is dispensed with at this juncture for the sake of clarity.

There is an air gap S between the stator 3 and the rotor 5.

A plurality of cooling recesses 15 are provided in the stator ring 16 in the region J of the magnetic yoke. A respective heat sink arrangement 14 is disposed in the cooling recesses 15, adapted for the dissipation of heat from the stator ring 16.

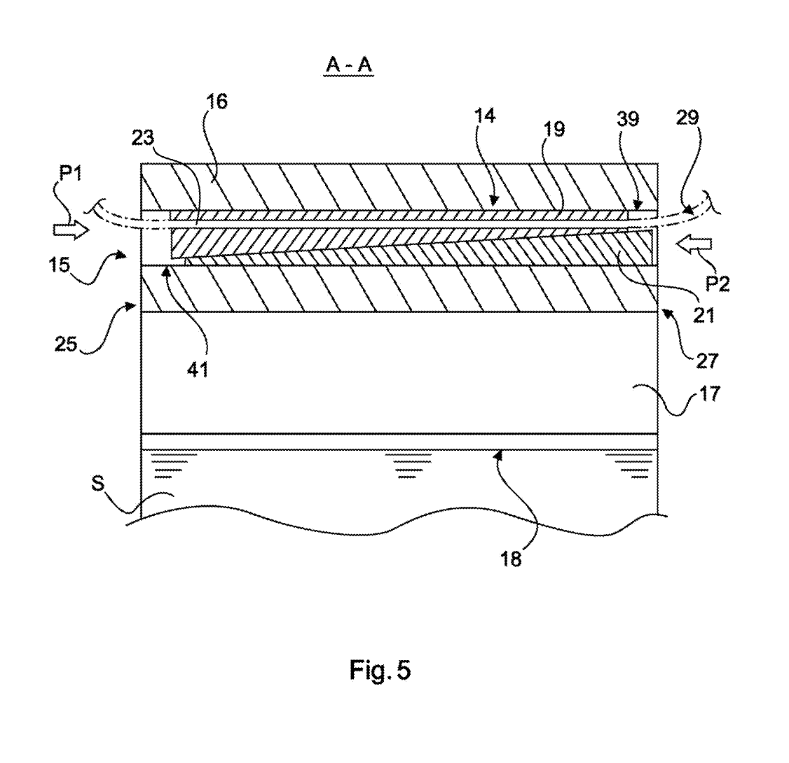

FIG. 5 shows further details relating to the heat sink arrangement 14.

The cross-sectional view in FIG. 5, along the section line A-A, shows the installation position of the heat sink arrangement 14. The heat sink arrangement 14 has a first heat sink 19 and a second heat sink 21. A cooling passage 23 extends through the first heat sink 19 in the axial direction (with respect to the axis of rotation of the stator ring). The cooling passage 23 is preferably connected to a cooling circuit 29. The cooling recess 15 extends from a first axial end 25 of the stator ring 16 to an opposite second axial end 27 of the stator ring 16.

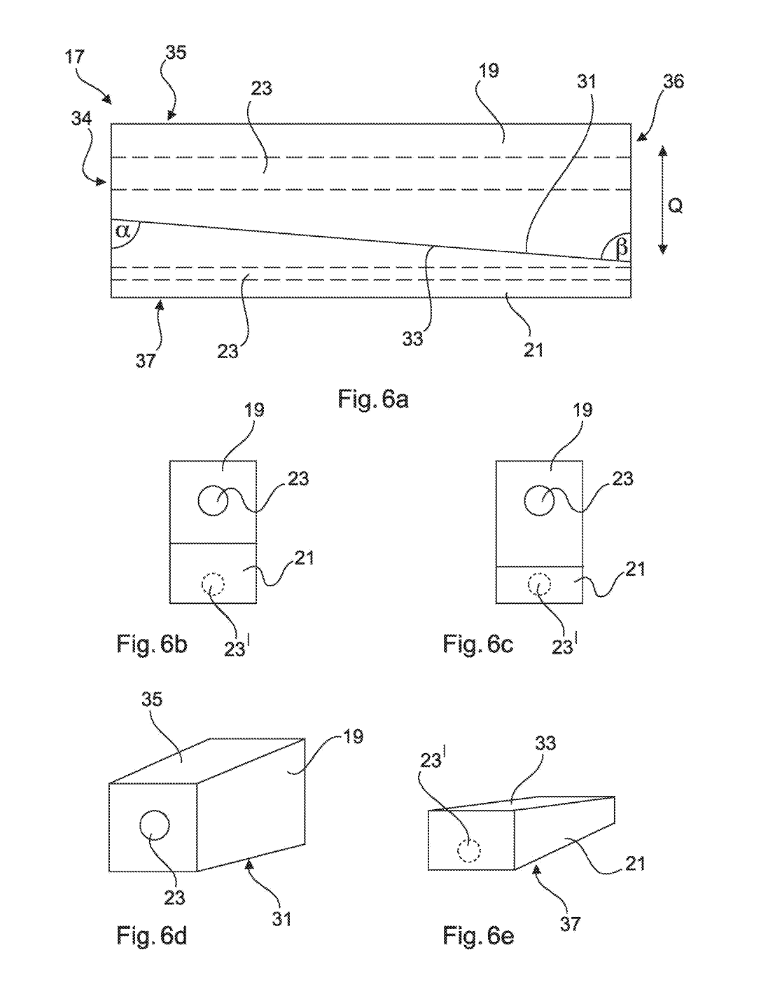

The first and second heat sinks 19, 21 have wedge surfaces 31, 33 (FIGS. 6a-e) which slide against each other and which are of such a configuration that, upon a displacement of the first heat sink 19 and the second heat sink 21 relative to each other in the direction of the arrows P₁ and/or P₂ the heat sinks 19, 21 are pressed against cooling walls 39, 41, that respectively face towards them, of the cooling recess 15. That provides for better heat transfer between the heat sink arrangement 14 and the stator ring 16. Further details relating to the first and second heat sinks 19, 21 can also be found in FIGS. 6a-e.

As shown in FIG. 6a the first and second heat sinks 19, 21 are so arranged relative to each other that a wedge surface 31 of the first heat sink 19 is in areal contact with a wedge surface 33 of the second heat sink 21. The two wedge surfaces 31, 33 respectively involve an angle α, β which is different from 90° in each case, in relation to the respective preferably substantially radially oriented ends 34, 36 of the heat sink arrangement 14. Particularly preferably the angles α, β are identical to each other. The angular orientation of the wedge surfaces 31, 33 provides that, upon displacement of the first and second heat sinks 19, 21 as indicated by the arrows P₁ and P₂ in FIG. 5, the spacing between a thermal coupling surface 35 of the first heat sink 19 and a thermal coupling surface 37 of the second heat sink 21 is altered in the direction of the arrow Q. In that way it is possible in a technically highly simple fashion for the heat sink arrangement to be pressed firmly into the cooling recess 15 and to ensure good heat transfer between the cooling walls 39, 41 on the one hand and the thermal coupling surfaces 35, 37 on the other hand.

In FIG. 6a-e, in accordance with a further preferred embodiment, there is optionally provided a second cooling passage 23 in the second heat sink 21. Alternatively or additionally a plurality of cooling passages can also be provided in one or both heat sinks 19, 21.

In regard to the cooling conduits themselves, many different geometrical arrangements are possible. The arrangement is no longer dependent on the strict cylindrical or hollow-cylindrical geometry of pipes, but for example any cooling conduit geometries, for example preferably meander-shaped cooling passages, can be implemented using an extrusion process. As an alternative to the illustrated rectangular wedge profile which is suited to the rectangular geometry of the cooling recess as shown in the foregoing Figures differing geometries are also conceivable in particular in respect of the thermal coupling surfaces 35, 37 which are each preferably adapted to the contour of the cooling recess and the cooling walls thereof.

1. A stator ring for an electric generator of a wind turbine, the stator ring comprising:
a plurality of grooves for receiving a stator winding, and
a magnetic yoke including:
at least one cooling recess in a region of the magnetic yoke, the at least one cooling recess having two mutually opposite cooling walls,
a first heat sink and a second heat sink arranged in the cooling recess and having respective mutually facing wedge surfaces which are operative to slide against each other, and
a respective thermal coupling surface opposite the wedge surface, the respective thermal coupling surface facing towards the cooling walls for dissipating heat energy from one of the cooling walls and operative to be displaced relative to each other such that the thermal coupling surfaces are pressed against the cooling walls.

2. The stator ring according to claim wherein at least one of the first heat sink and the second heat sink has at least one fluid passage for connection to a fluid cooling system.

3. The stator ring according to claim 1, wherein a contour of the thermal coupling surfaces of the first and second heat sinks is adapted to a contour of the cooling wall.

4. The stator ring according to claim 1, wherein at least one of the thermal coupling surfaces and the wedge surfaces are provided with a heat-conducting paste.

5. The stator ring according to claim 1, wherein at least one of the first heat sink and the second heat sink is at least partially formed from one of: aluminum, aluminum alloy, copper and copper alloy.

6. The stator ring according to claim 2 wherein the at least one of the first heat sink and the second heat sink has a multi-part configuration in which a first portion of the at least one of the first heat sink and the second heat sink has the wedge surface and a second portion of the at least one of the first heat sink and the second heat sink has the at least one fluid passage.

7. The stator ring according to claim 1, wherein the two mutually opposite cooling walls of the at least one cooling recess are spaced from each other in a radial direction of the stator ring.

8. The stator ring according to claim 1, wherein the two mutually opposite cooling walls of the at least one cooling recess are spaced from each other in a peripheral direction in relation to the stator ring.

9. The stator ring according to claim 1, comprising:
a plurality of stator lamination sets, wherein the at least one cooling recess extends through the stator lamination sets.

10. The stator ring according to claim 1, wherein the at least one cooling recess has a rectangular cross-section.

11. The stator ring according to claim 1, wherein the at least one cooling recess has a recess provided for mounting of the stator ring.

12. An electric generator of the wind power installation, comprising:
a rotor, and
a stator having the stator ring according to claim 1.

13. A wind power installation, comprising the electric generator according to claim 12.

14. A method comprising:
dissipating thermal energy using a heat sink arrangement from a cooling recess in the stator ring of an electric generator of a wind power installation, wherein the cooling recess has two mutually opposite cooling walls and wherein the heat sink arrangement has a first and a second heat sink which respectively have thermal coupling surfaces facing towards respective cooling walls and are displaced relative to each such that the thermal coupling surfaces are pressed against the cooling walls.

15. The stator ring according to claim 1, wherein the electric generator is a synchronous generator or a ring generator.

16. The stator ring according to claim 5, wherein the at least one of the first heat sink and the second heat sink is completely formed from the one of: aluminum, aluminum alloy, copper and copper alloy.

17. The stator ring according to claim 9, wherein the at least one cooling recess extends through the stator lamination sets from a first axial end of the stator ring to an opposite second axial end of the stator ring.

18. The stator ring according to claim 11, wherein the recess is subsequently enlarged for adaptation to the first and second heat sinks.
